(19) United States
(12) Patent Application Publication
(10) Pub. No.: US 2010/0040828 A1
(43) Pub. Date: Feb. 18, 2010

(54) Latch cover

(75) Inventor: Walter L. Cook, Bellevue, WA (US)

Correspondence Address: JENSEN + PUNTIGAM, P.S., 2033 6th Ave, Suite 1020, SEATTLE, WA, 98121, US

(73) Assignee: Harper Engineering Co., Renton, WA (US)

(21) Appl. No.: 12/228,756

(22) Filed: Aug. 15, 2008

(51) Int. Cl. B32B 3/12

(52) U.S. Cl. 428/116

(57) ABSTRACT

A lightweight, strong article of manufacture wherein the surfaces are fabricated of an adhesive-impregnated fiber fabric having the desired properties; and where additional stiffness is required, a honeycomb material is sandwiched between the surfaces, greatly increasing the rigidity with only a slight increase in weight.

### TECHNICAL FIELD

This invention relates to a latch cover used in stowage compartments to protect the latch mechanism inside the compartments, and more particularly to a cover which is fabricated of a sandwich of relatively thin, rugged composite surface elements capturing an interior honeycomb element, including outwardly projecting edges of the surface elements for securement of the cover to the compartments.

### BACKGROUND OF THE INVENTION

When using public transportation, passengers' personal belongings and luggage are often stowed in overhead compartments which, because of their limited is capacity, are often overloaded, which could lead to damage of the compartments, latches and/or the stowed material. Since these compartments are, for safety reasons, closed and latched during transportation, it is imperative that the latching mechanisms be protected from damage caused by the materials stowed within the compartment.

Historically, the latch protective covers have been fabricated of aluminum or some other lightweight metal which provided sufficient strength and integrity to protect the latch mechanism. The ever-increasing cost of fuel has caused the operators of public transportation, and in particular airplanes, to look for ways to reduce weight and thus the cost of operating the vehicle.

With the above-noted background in mind, efforts have been made to reduce the weight of a vehicle by reducing the weight of various components. The use of composites has been explored. The difficulty with composites of sufficient strength and integrity to withstand the stresses encountered in the stowage compartments has been that they needed to be relatively thick, consuming more compartment volume, and did not significantly reduce the weight of the vehicle.

### SUMMARY OF THE INVENTION

In addition to reducing weight and providing sufficient strength, it is a goal of the present invention to reduce bulk, thereby increasing the available storage space.

A thin, easily molded, but strong cover to protect the latch is realized as a result of combining a composite skin sandwiching a honeycomb core, wherein the skins extend beyond the core to form a surface securement to the remainder of the stowage compartment.

It is further recognized that the inventive design is not limited to specific application of a latch cover, but could easily be adapted to applications, including air foils, protective covers in other environments and other places where there is a distinct advantage for a thin, lightweight, strong and durable panel. It should be understood that the composite skins could use fibers of glass, carbon, Kevlar®, basalt or any other high strength, lightweight fiber and could include chemical or gas-impervious surfaces.

### BRIEF DESCRIPTION OF THE DRAWINGS

FIG. 1 is an environmental view showing upper stowage compartments for an airplane with a cutaway of the latch cover in place.

FIG. 2 is an enlarged view of the cutaway portion of FIG. 1 with the inventive latch cover in place.

FIG. 3 is a perspective view of the latch cover.

FIG. 4 is a sectional view along lines 4-4 of FIG. 3, further illustrating a strengthening sandwich structure in conjunction with outwardly extending edges for securement of the basic element.

### BEST MODE FOR CARRYING OUT THE INVENTION

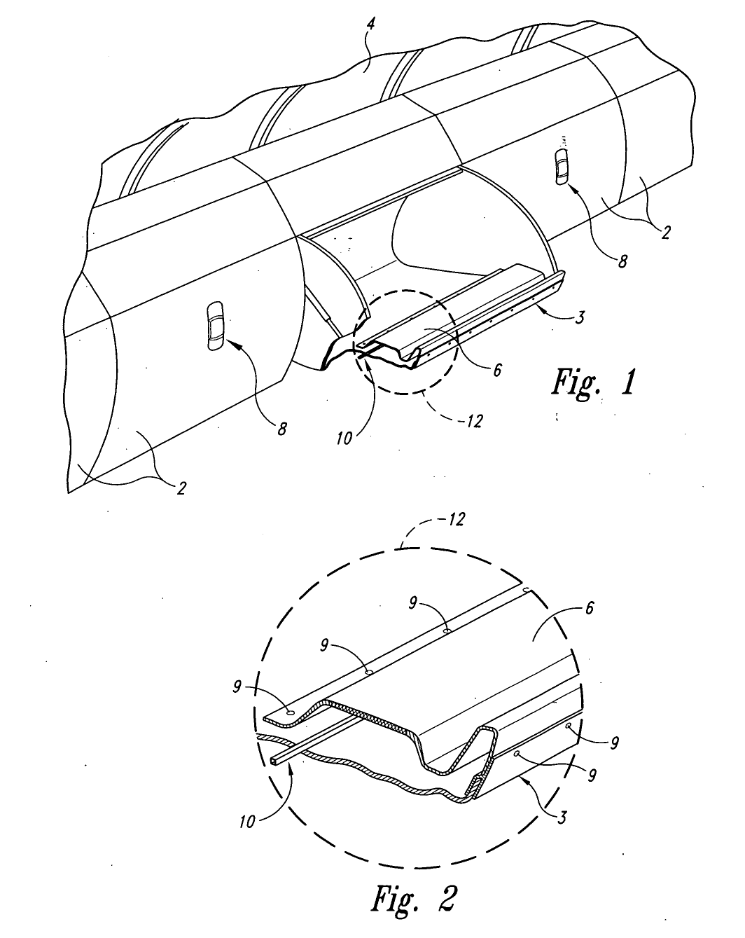

As seen in FIG. 1, the overhead stowage compartments 2 are pivotally secured to the interior 4 of an airplane, and as shown in one open stowage compartment 3, the latch cover 6, protects the operating mechanism 8 and the torque tube 10, protecting them from damage when the luggage is placed within the stowage compartment.

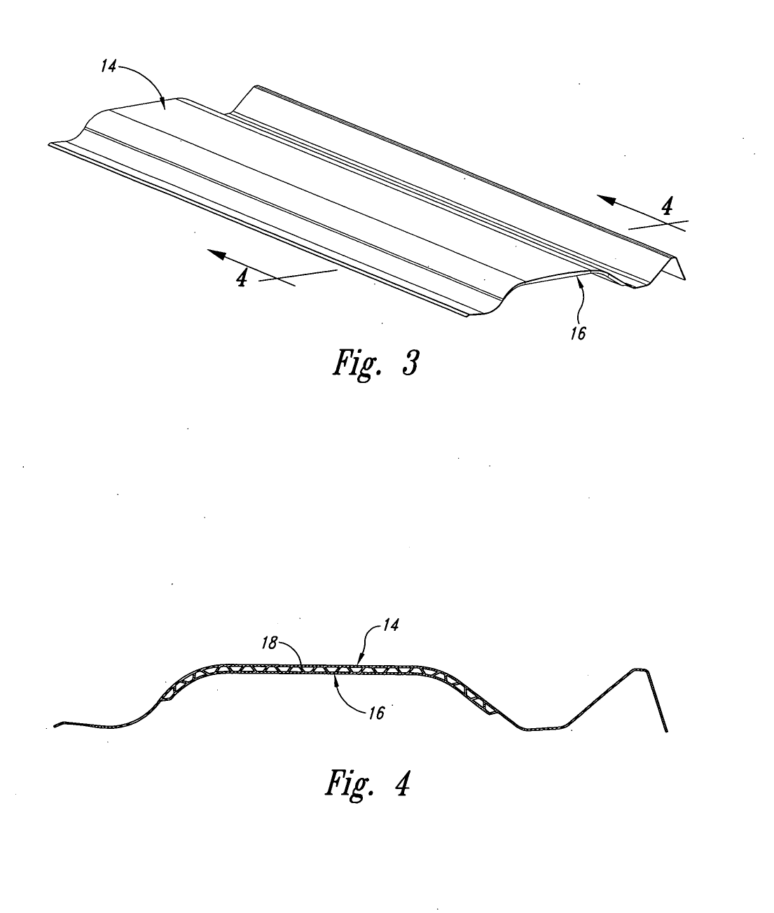

Reference is now had to FIG. 2, wherein the cutaway view 12 of the open overhead stowage compartment 3, shown in FIG. 1, is shown enlarged and includes the view, the means 9 of securing the latch cover 6 to the stowage compartment 3 is depicted. The torque tube cover 6 will now be described in greater detail with respect to FIGS. 3 and 4.

Reference is now had to FIG. 3, wherein the latch cover 6 includes an upper skin 14 and a lower skin 16 which are bonded together to form a unified element and forms a selected composite surface and, as explained hereinafter, has superior strength. It is to be understood that the skins 14, 16 could be fabricated of any material that has both high tensile and high compressive strengths, and can be coated with a durable protective coating, preferably Kevlar®.

As is best shown in FIG. 4, the material between the separated portions of interior and exterior skins 14 and 16, respectively, is a honeycomb material 18 (NOMEX).

In manufacturing the structure, the composite skin material, be it fiberglass, carbon fiber, basalt fiber, Kevlar® fiber, or any other high strength, low weight pre-impregnated fabric, is placed into a mold along with the honeycomb material located in the designated area, and then the entire composite is subjected to heat and pressure to cure the adhesive, to bond the materials to each other wherever they are in contact. As can be seen, the present invention results in a unitary sandwich having properties that can be utilized in many lightweight structures requiring durable lightweight panels.

Although a preferred embodiment of the invention has been disclosed herein for the purpose of illustration, it should be understood that various changes, modifications and substitutions may be incorporated in the embodiment without departing from the spirit of the invention, which is defined by the claims which follow.

What is claimed is:

1. (canceled)

2. A latch cover to protect the operating mechanism in a stowage compartment, comprising:
an elongated, continuous rigid cover element fabricated of a pair of thin adhesive-impregnated fiber fabric surface elements capturing an interior localized honeycomb element, wherein the surface elements are bonded to the honeycomb element and to each other beyond the honeycomb element around the periphery and compressed in such a manner that the honeycomb is compressed to a specific reduced thickness.

3. A cover as in claim 2, wherein the cover is outwardly curved along the longitudinal axis.

4. A cover as in claim 2, wherein the cover clement is a select one of fiberglass, carbon fiber, basalt fiber, para-aramid fiber, or any other high-strength, low-weight fiber fabric.

5. A cover as in claim 2, wherein the cover elements extend beyond a localized honeycomb element and provide means for attachment.
